(19) United States
(12) Patent Application Publication
(10) Pub. No.: US 2009/0033548 A1
(43) Pub. Date: Feb. 5, 2009

(54) System and method for volume visualization in through-the-obstacle imaging system

(75) Inventors: Benjamin David Boxman, Herzilya (IL); Amir Beeri, Zoran (IL)

Correspondence Address: OLIFF & BERRIDGE, PLC, P.O. BOX 320850, ALEXANDRIA, VA, 22320-4850, US

(73) Assignee: CAMERO-TECH LTD., Kfar Neter (IL)

(21) Appl. No.: 12/149,738

(22) Filed: May 7, 2008

(30) Foreign Application Priority Data
Aug. 1, 2007 (IL) 184972

(51) Int. Cl. G01S 13/00

(52) U.S. Cl. 342/179

(57) ABSTRACT

Herewith disclosed a computerized method of volume visualization, a volume visualization unit and through-the-obstacle imaging system capable of volume visualization. The method of volume visualization comprises obtaining one or more volumetric data sets corresponding to physical inputs informative, at least, of a part of an imaging scene concealed by one or more obstacles and obtained by a sensor array; obtaining data informative of position and/or orientation of the sensor array corresponding to said obtained physical inputs; pre-processing one or more obtained volumetric data sets and/or derivatives thereof in accordance with said position and/or orientation informative data; volume visualization processing one or more obtained volumetric data sets and/or derivatives thereof in accordance with results of pre-processing.

### FIELD OF THE INVENTION

This invention relates to through-the-obstacle imaging systems and, more particularly, to volume visualization in through-the-obstacle imaging systems.

### BACKGROUND OF THE INVENTION

“Seeing” through obstacles such as walls, doors, ground, smoke, vegetation and other visually obstructing substances, offers powerful tools for a variety of military and commercial applications. Through-the-obstacle imaging can be used in rescue missions, behind-the-wall target detection, surveillance, reconnaissance, science, etc. The applicable technologies for through-the-obstacle imaging include impulse radars, UHF/microwave radars, millimeter wave radiometry, X-ray transmission and reflectance, acoustics (including ultrasound), magneto-metric, etc.

The problem of effective volume visualization based on obtained signal and presenting 3D data on an image display in relation to a real world picture, has been recognized in prior art and various systems have been developed to provide a solution, for example:

U.S. Pat. No. 6,970,128 (Adams et al.) entitled “Motion compensated synthetic aperture imaging system and methods for imaging” discloses a see-through-the-wall (STTW) imaging system using a plurality of geographically separated positioning transmitters to transmit non-interfering positioning signals. An imaging unit generates a synthetic aperture image of a target by compensating for complex movement of the imaging unit using the positioning signals. The imaging unit includes forward and aft positioning antennas to receive at least three of the positioning signals, an imaging antenna to receive radar return signals from the target, and a signal processor to compensate the return signals for position and orientation of the imaging antenna using the positioning signals. The signal processor may construct the synthetic aperture image of a target from the compensated return signals as the imaging unit is moved with respect to the target. The signal processor may determine the position and the orientation of the imaging unit by measuring a relative phase of the positioning signals.

US Patent Application No. 2003/112170 (Doerksen et al.) entitled “Positioning system for ground penetrating radar instruments” discloses an optical positioning system for use in GPR surveys that uses a camera mounted on the GPR antenna that takes video of the surface beneath it and calculates the relative motion of the antenna based on the differences between successive frames of video.

International Application No. PCT/IL2007/000427 (Beeri et al.) filed Apr. 1, 2007 and entitled “System and Method for Volume Visualization in Ultra-Wideband Radar” disclosed a method for volume visualization in ultra-wideband radar and a system thereof. The method comprises perceiving processing provided in order to facilitate a meaningful representation and/or an instant understanding of the image to be displayed, said perceiving processing resulted in generating one or more perceiving image ingredients.

### SUMMARY OF THE INVENTION

In accordance with certain aspects of the present invention, there is provided a method of volume visualization for use with a through-the-obstacle imaging system comprising at least one sensor array configured to obtain physical inputs informative, at least, of a part of an imaging scene concealed by one or more obstacles, the method comprising:
obtaining one or more volumetric data sets corresponding to the physical inputs obtained by the sensor array;
obtaining data informative of position and/or orientation of the sensor array corresponding to said obtained physical inputs;
pre-processing one or more obtained volumetric data sets and/or derivatives thereof in accordance with said position and/or orientation informative data;
volume visualization processing one or more obtained volumetric data sets and/or derivatives thereof in accordance with results of pre-processing.

In certain embodiments of the invention said sensor array may be an antenna array of an ultra-wideband radar.

In accordance with other aspects of the present invention, there is provided a through-the-obstacle imaging system comprising:
at least one sensor array operatively coupled to a signal acquisition and processing unit, said sensor array comprising one or more image sensors configured to obtain physical inputs informative of, at least, a part of an imaging scene concealed by one or more obstacles, and to generate respective output signal, said signal and/or derivatives thereof to be transferred to said signal acquisition and processing unit configured to receive said signal and/or derivatives thereof and to generate, accordingly, at least one volumetric data set;
a volume visualization unit operatively coupled to the signal acquisition and processing unit and configured to obtain one or more volumetric data sets, to provide volume visualization processing in accordance with the obtained volumetric data sets, and to facilitate displaying the resulting image; wherein the volume visualization unit comprises a visualization adjustment block configured to provide certain pre-processing of one or more obtained volumetric data sets and/or derivatives thereof, the results of the pre-processing to be used in further volume visualization processing;
at least one sensor configured to obtain data informative of position and/or orientation of the sensor array and to transfer the data and/or derivatives thereof to the visualization adjustment block; wherein the visualization adjustment block is configured to provide said pre-processing in accordance with said position and/orientation informative data and certain rules.

In certain embodiments of the invention said imaging system may be based on an ultra-wideband radar.

In accordance with further aspects of the present invention, at least one sensor configured to obtain data informative of position and/or orientation of the sensor array may be selected from a group comprising an accelerometer, an inclinometer, a laser range finder, a camera, an image sensor, a gyroscope, GPS, a combination thereof.

In accordance with further aspects of the invention, the visualization adjustment block is further operatively coupled to the signal acquisition and processing unit and configured to transfer the results of pre-processing to said unit, while the signal acquisition and processing unit is configured to modify one or more parameters characterizing generating volumetric data in accordance with received results of pre-processing.

In accordance with other aspects of the present invention, there is provided a volume visualization unit for use with a through-the-obstacle imaging system comprising at least one sensor array, the volume visualization unit configured to obtain one or more volumetric data sets, to provide volume visualization processing in accordance with the obtained volumetric data sets, and to facilitate displaying the resulting image; wherein said volume visualization unit comprises a visualization adjustment block configured to obtain data informative of position and/or orientation of the sensor array and to provide pre-processing of the obtained one or more volumetric data sets and/or derivatives thereof, the results of the pre-processing to be used for further volume visualization processing, wherein said pre-processing to be provided in accordance with said position and/or orientation informative data and certain rules.

In accordance with other aspects of the present invention, there is provided a method of volume visualization for use with an ultra-wideband radar imaging system comprising at least one antenna array, the method comprising:
obtaining one or more volumetric data sets corresponding to the physical inputs obtained by the antenna array;
obtaining data informative of position and/or orientation of the antenna array corresponding to said obtained physical inputs;
pre-processing one or more obtained volumetric data sets and/or derivatives thereof in accordance with said position and/or orientation informative data thus giving rise to adjusted volumetric data sets;
volume visualization processing in respect of the adjusted volumetric data set.

In accordance with other aspects of the present invention, there is provided a method of volume visualization for use with an ultra-wideband radar imaging system comprising at least one antenna array, the method comprising:
obtaining one or more volumetric data sets corresponding to the physical inputs obtained by the antenna array;
obtaining data informative of position and/or orientation of the antenna array corresponding to said obtained physical inputs;
generating a visualization mode in accordance with obtained orientation and/or position informative data;
volume visualization processing one or more obtained volumetric data sets and/or derivatives thereof in accordance with the generated visualization mode.

In accordance with either of the above-mentioned aspects of the invention, the position and/or orientation informative data may be related, for example, to orientation and/or position versus the gravitational vector; orientation and/or position versus certain elements of the imaging scene; orientation and/or position versus a previous orientation and/or position, etc.

In accordance with either of the above-mentioned aspects of the invention, the pre-processing may give rise to an adjusted volumetric data set and the volume visualization processing comprises processing provided in respect of said adjusted volumetric data set. The adjustment may comprise at least one of the following:
rotating and/or shifting at least one volumetric data set in order to provide alignment with a certain reference;
filtering at least one obtained volumetric data set in accordance with certain criteria;
aggregating two or more obtained volumetric data sets and rotating and/or shifting the aggregated volumetric data in order to provide alignment with a certain reference;
rotating and/or shifting two or more obtained volumetric data sets in order to provide alignment with a common reference and aggregating the adjusted volumetric data sets;
rotating and/or shifting at least one volumetric data set in order to correct the deviation in respect to a previous orientation and/or position.

In accordance with either of the above-mentioned aspects of the invention, the pre-processing may comprise at least one of the following:
generating a visualization mode in accordance with obtained orientation and/or position informative data and certain rules;
selecting, in accordance with obtained orientation and/or position informative data, one or more perceiving image elements to be generated during volume visualization processing;
automated configuring parameters of volume visualization processing in accordance with obtained orientation and/or position informative data;
   while the volume visualization processing comprises processing one or more obtained and/or adjusted (and/or otherwise derived) volumetric data sets in accordance with the generated visualization mode.

In accordance with further aspects of the present invention, generation of the visualization mode may comprise selection of a certain visualization mode among one or more predefined visualization modes. The parameters characterizing the pre-defined visualization mode may be predefined, calculated and/or selected in accordance with obtained orientation and/or position informative data.

In accordance with further aspects of the present invention, if at least one obstacle is an element of a construction (e.g. a floor, a structural wall, a ground, a ceiling, etc.), at least one predefined visualization mode may be selected from a group comprising a floor/ground mode, a wall mode and a ceiling mode.

### BRIEF DESCRIPTION OF THE DRAWINGS

In order to understand the invention and to see how it may be carried out in practice, certain embodiments will now be described, by way of non-limiting example only, with reference to the accompanying drawings, in which:

FIG. 1 illustrates a generalized block diagram of a through-the obstacle imaging system as known in the art;

FIG. 2 illustrates a generalized block diagram of a through-the obstacle imaging system in accordance with certain embodiments of the present invention;

FIG. 3 illustrates a generalized flow chart of an imaging procedure in accordance with certain embodiments of the present invention;

FIG. 4 illustrates a generalized flow chart of an imaging procedure in accordance with certain other embodiments of the present invention;

FIG. 5 illustrates generation of visualization mode in accordance with the orientation in the through-wall imaging context; and

FIGS. 6a and 6b illustrate fragments of a sample screen comprising an exemplary image visualized in accordance with certain aspects of the present invention.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. In the drawings and description, identical reference numerals indicate those components that are common to different embodiments or configurations.

Unless specifically stated otherwise, as apparent from the following discussions, it is appreciated that throughout the specification discussions utilizing terms such as “processing”, “computing”, “calculating”, “determining”, “generating” or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

The terms “volume visualization” used in this patent specification include any kind of image-processing, volume rendering or other computing used to facilitate displaying three-dimensional (3D) volumetric data on a two-dimensional (2D) image surface or other display media.

The terms “perceive an image”, “perceiving processing” or the like used in this patent specification include any kind of image-processing, rendering techniques or other computing used to provide the image with a meaningful representation and/or an instant understanding, while said computing is not necessary for the volume visualization. Perceiving processing may include 2D or 3D filters, projection, ray casting, perspective, object-order rendering, compositing, photo-realistic rendering, colorization, 3D imaging, animation, etc., and may be provided for 3D and/or 2D data.

The term “perceiving image ingredient” used in this patent specification includes any kind of image ingredient resulting from a perceiving processing as, for example, specially generated visual attributes (e.g. color, transparency, etc.) of an image and/or parts thereof, artificially embedded objects or otherwise specially created image elements, etc.

Embodiments of the present invention may use terms such as, processor, computer, apparatus, system, sub-system, module, unit, device (in single or plural form) for performing the operations herein. This may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, Disk-on-Key, smart cards (e.g. SIM, chip cards, etc.), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions capable of being conveyed via a computer system bus.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The references cited in the background teach many principles of image visualization that are applicable to the present invention. Therefore the full contents of these publications are incorporated by reference herein where appropriate, for appropriate teachings of additional or alternative details, features and/or technical background.

In the drawings and descriptions, identical reference numerals indicate those components that are common to different embodiments or configurations.

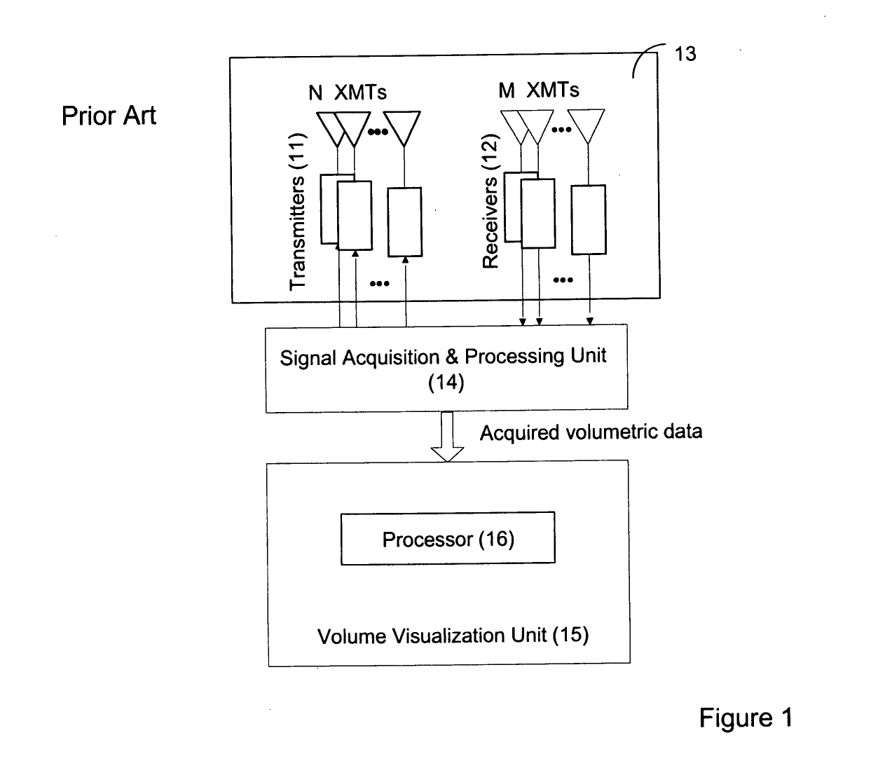

Bearing this in mind, attention is drawn to FIG. 1 illustrating a generalized block diagram of a through-the obstacle imaging system as known in the art.

For purpose of illustration only, the following description is made with respect to an imaging system based on a UWB radar. The illustrated imaging system comprises N≧1 transmitters (11) and M≧1 receivers (12) (together referred hereinafter as “image sensors”) arranged in (or coupled to) at least one antenna array (13) referred to hereinafter as a “sensor array”. Typically, the sensor array is arranged on a rigid body. At least one transmitter transmits a pulse signal (or other form of UWB signal, such as, for example, M-sequence coded signal, etc.) to a space to be imaged and at least one receiver captures the scattered/reflected waves. To enable high quality imaging, sampling is provided from several receive channels. The process is repeated for each transmitter separately or simultaneously with different coding per each transmitter (e.g. M-sequence UWB coding).

It should be noted that the present invention is applicable in a similar manner to any other sensor array comprising active and/or passive sensors configured to obtain physical inputs informative, at least, of a part of an imaging scene concealed by an obstacle (e.g. magnetic sensors, ultrasound sensors, radiometers, etc.) and suitable for through-the-obstacle imaging.

The received signals are transferred to a signal acquisition and processing unit (14) coupled to the sensor array (13). The signal acquisition and processing unit is capable of receiving the signals from the sensor array, of providing the integration of the received signals and processing the received signals in order to provide 3D volumetric data.

The obtained volumetric data are transferred to a volume visualization unit (15) operationally coupled to the signal acquisition/processing unit and comprising a processor (16). The volume visualization unit is configured to provide volume visualization, and to facilitate displaying the resulting image on the screen. The calculations necessary for volume visualization are provided by the processor (16) by using different appropriate techniques, some of them known in the art.

Note that the invention is not bound by the specific UWB radar structure described with reference to FIG. 1 or volume visualization technique. Those versed in the art will readily appreciate that the invention is, likewise, applicable to any other through-the-obstacle imaging system. Also it should be noted that the functionality of the plurality of physical antenna elements may be also provided by synthetic aperture radar techniques.

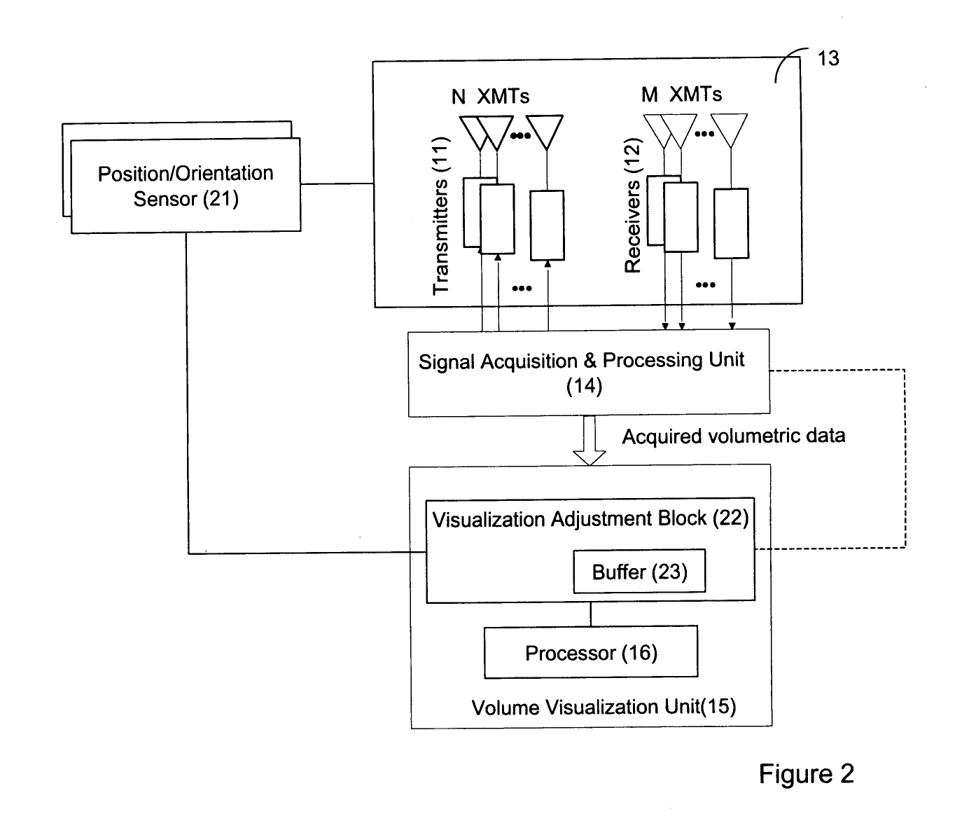

FIG. 2 illustrates a generalized block diagram of a through-the-obstacle imaging system in accordance with certain embodiments of the invention. Orientation and/or position of the sensor array (13) may be changed during operating the imaging system (e.g. because of complex motion of a user, etc.). In accordance with certain embodiments of the invention the through-the-obstacle imaging system comprises at least one sensor (21) able to determine position and/or orientation of at least one sensor array and to provide the obtained data to the volume visualization unit (15). For purpose of illustration only, the following description is made with respect to a single sensor array arranged on a rigid body. In such embodiments wherein positions and/or orientations of all image sensors are characterized by a position/orientation of the rigid body, a sensor configured to determine orientation and/or position of the rigid body may determine the position and/or orientation of respective image sensors. It should be noted, however, that the present invention is applicable in a similar manner to any other sensor array suitable for a through-the-obstacle imaging system. For example, in a case of a distributed array comprising one or more sub-arrays with one or more image sensors and arranged on different rigid bodies, different non-rigid bodies and/or different parts of a non-rigid body, or otherwise, the imaging system may comprise one or more orientation/position sensors configured to determine orientation and/or position of such sub-arrays, optionally, also relative orientation/position of the sub-arrays and elements thereof in relation to each other. In certain embodiments of the invention each sub-array (and/or sensors thereof) may be provided with orientation/position sensor, while in other embodiments orientation/position of part of sub-arrays (and/or sensors thereof) may be calculated or ignored in accordance with certain rules).

The orientation/position sensor(s) may be an accelerometer, digital inclinometer, laser range finder, gyro, camera, GPS, the system's image sensors, combination thereof, etc. The sensor(s) may ascertain the orientation of the system versus the gravitational vector, the orientation and/or position versus a target and/or elements of a scene (e.g. walls, floor, ceiling, etc.), the orientation versus a previous orientation, position versus a previous position, etc.

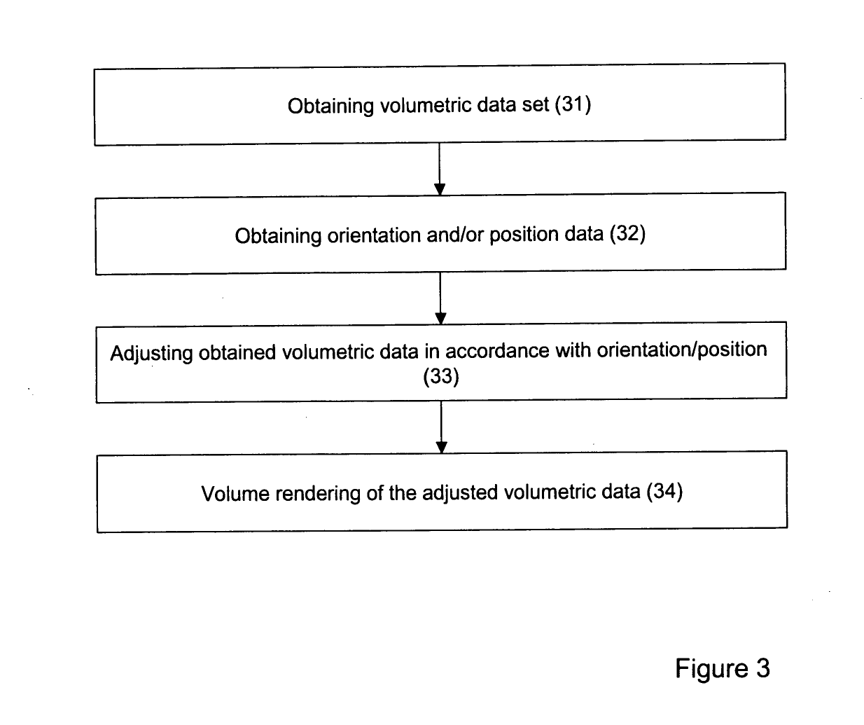

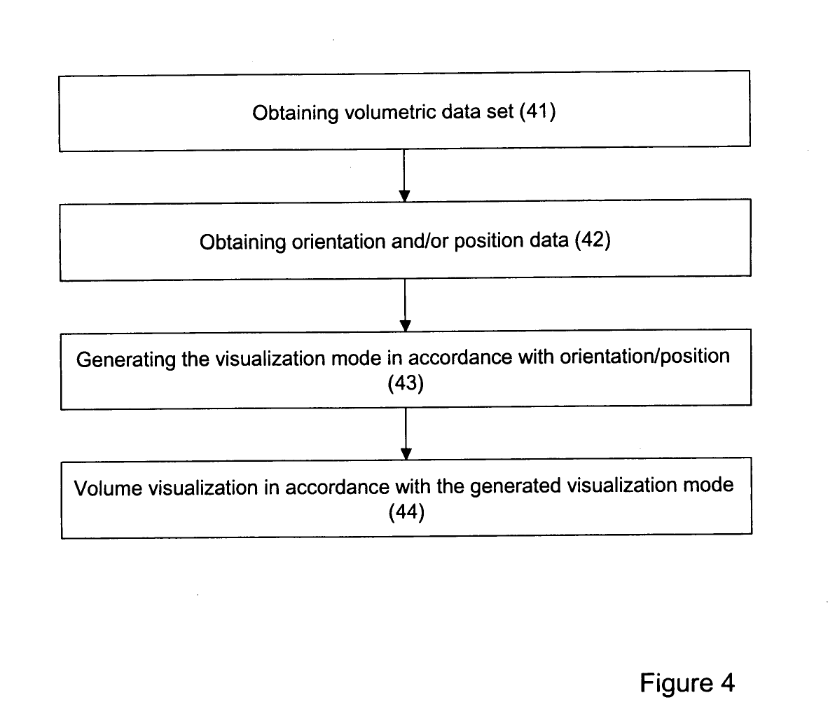

In accordance with certain embodiments of the invention, the volume visualization unit (15) comprises a visualization adjustment block (22) operatively coupled to the processor (16) and configured to receive orientation/position data, to provide a pre-processing of the obtained volumetric data in accordance with the position/orientation data and certain rules further detailed with reference to FIGS. 3-4, and to transfer the results to the processor. In the illustrated embodiment the sensor is operatively coupled to the sensor array and to the visualization adjustment block.

Optionally, the visualization adjustment block may be operatively coupled to the signal acquisition and processing unit (14) and be configured to transfer the results of pre-processing to said unit (as will be further detailed with reference to FIGS. 3 and 4).

Optionally, the visualization adjustment block may comprise a buffer (23) configured to accumulate one or more sets of volumetric data (e.g. corresponding to one or more frames) for pre-processing further described with reference to FIGS. 3 and 4.

Those skilled in the art will readily appreciate that the invention is not bound by the configuration of FIG. 2; equivalent and/or modified functionality may be consolidated or divided in another manner and may be implemented in software, firmware, hardware, or any combination thereof.

Referring to FIGS. 3 and 4, there are illustrated generalized flow charts of imaging procedure in accordance with certain embodiments of the present invention.

The imaging procedure comprises obtaining (31 or 41) volumetric data by any suitable signal acquisition and processing technique, some of them known in the art.

The imaging procedure also comprises-obtaining (32 or 42) data related to position and/or orientation of at least one sensor array comprising one or more image sensors. The orientation/position may be determined, for example, versus the gravitational vector (e.g. by an accelerometer, inclinometer, etc.); versus certain elements of a scene as, for example, walls, floor, ceiling, etc. (e.g. by a group of laser range finders, a set of cameras, by image sensors comprised in the sensor array (e.g. in a radar a pair transmitter/receiver may act as a range-finder, etc.); versus a previous orientation/position (e.g. by a composed sensor comprising a combination of accelerometers and gyroscopes, etc.). In certain embodiments of the invention the imaging system may obtain the orientation/position data without any dedicated sensor by analyzing the acquired signal (e.g. by finding the most likely shift+rotation that makes the current volumetric set most akin to the previous one, etc.). Such functionality may be provided by, for example, by the image adjustment block configured to provide the required calculations.

Those versed in the art will readily appreciate that the operations (31/41) and (32/42) may be also performed concurrently or in the reverse order.

The image procedure further comprises pre-processing of the obtained volumetric data in accordance with obtained orientation/position data and certain rules and further volume visualization processing in accordance with pre-processing results.

Accordingly, in the embodiments illustrated with reference to FIG. 3, the pre-processing comprises adjusting (33) the obtained volumetric data in accordance with obtained orientation/position data (e.g. by the visualization adjustment block 22). The adjusting may comprise rotating and/or shifting the obtained volumetric data (one or more data sets or accumulated data) in order to provide alignment with a certain reference, filtering the obtained volumetric data in accordance with certain criterion, etc. The adjusted volumetric data set is further processed (34) to provide volume visualization.

For example, if the obtained orientation/position data comprise data related to orientation versus a gravitation vector, the obtained volumetric data set will be rotated in order to correct the deviation (e.g. pitch and roll) of the sensor array versus the gravitation vector. By way of non-limiting example, if the obtained orientation data indicates that the sensor array points slightly downwards, the volumetric data set will be rotated back upwards; likewise, if the data indicates that the sensor array is slanting sideways, the volumetric set will be rotated to correct the slant.

If the obtained orientation/position data comprise data related to orientation versus certain scene elements, the obtained volumetric data will be rotated/shifted in order to correct deviation (e.g. yaw and pitch) in respect to said elements (e.g. wall, ceiling, floor, etc.). Certain additional information or assumption about the scene, e.g. that the user is standing on a flat surface (floor/ground) and/or has a flat plane above the system (ceiling), enable to calculate the roll in relation to at least one of said planes and to adjust (rotate) the obtained volumetric data set accordingly.

The obtained volumetric data may be filtered, for example, in accordance with obtained position/orientation and knowledge about the scene. By way of non-limiting example, pre-processing may comprise calculation of orientation/position versus an obstacle (e.g. wall) and filtering the volumetric data in a manner that only data corresponding to the volume behind the obstacle will be transferred for further visualization processing.

If the obtained orientation/position data comprise data related to orientation and/or position versus previous orientation/position, the adjustment of the obtained volumetric data comprises rotating and/or shifting the volumetric data in order to correct the deviation in respect to the initial position (e.g. in order to compensate the motion). Optionally, the pre-processing may comprise accumulating several volumetric data sets (e.g. in the buffer 23), and aggregating the resulting volumetric data before the adjustment.

The different procedures (described above and another) of adjusting the obtained volumetric data may be combined together. For example, several volumetric data sets obtained from several positions/angles may be adjusted to one certain position/angle and aggregated together, thus providing a volumetric data set comprising more complete information of the scene/target.

Shifting and/or rotating the obtained volumetric data set and aggregating several data sets may be provided by different techniques, some of them known in the art (see, for example, “Chen B., Kaufman A., 3D Volume Rotation Using Shear Transformations, Graphical Models, Volume 62, Number 4, July 2000, pp. 308-322(15)”).

Referring to the image procedure illustrated in FIG. 4, pre-processing of the obtained volumetric data comprises generating (43) a visualization mode in accordance with obtained orientation/position data and certain rules and further volume visualization (44) in accordance with the generated mode.

In accordance with certain embodiments of the invention, the volume visualization may be provided in accordance with a certain visualization mode. The term “visualization mode” used in this patent specification includes any configuration of volume visualization-related parameters and/or processes (and/or parameters thereof) to be used during volume visualization. The generation of a visualization mode includes automated selection of a fully predefined configuration (e.g. configuration corresponding to viewing a scene through a wall, floor, or ceiling in through-wall imaging applications), and/or automated configuration of certain parameters (e.g. maximal range of signals of interest) and/or processes and parameters thereof (e.g. certain perceiving image ingredient(s) to be generated), etc.

Optionally, in certain embodiments of the invention the visualization mode generating may include involvement of the user, e.g. user may be requested to enter and/or authorize one or more parameters during the generation and/or authorize the generated visualization mode or parts thereof before further volume visualization processing.

In a case of multiple sensor sub-arrays with substantially independent orientation/position measured by respective position/orientation sensors, the pre-processing may be provided in accordance with certain rules. By way of non-limiting example, adjustment of volumetric data may be provided separately for each volumetric data set obtained from respective image sensors; generating the visualization mode made be provided in accordance with, for example, orientation/position of a majority of sub-arrays, etc.

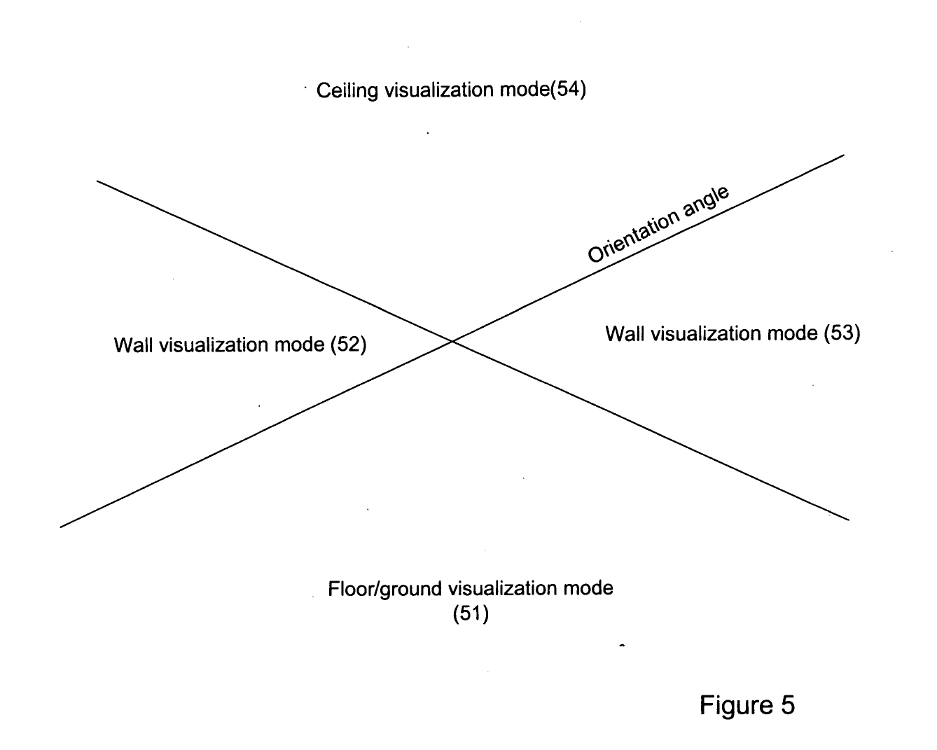

FIG. 5 illustrates by way of non-limiting example generation of visualization mode in accordance with the orientation in the through-wall imaging context. The illustrated embodiment is related to a case when at least one obstacle (e.g. a floor, a structural wall, a ground, a ceiling, etc.) is a part of certain construction, e.g. a building or other assembly of any infrastructure. In accordance with certain embodiments of the present invention, the overall range of orientation angles is divided in 4 parts corresponding to different visualization modes: floor/ground mode (51), wall mode (52, 53) and ceiling mode (54). Those skilled in the art will readily appreciate that invention is not limited by illustrated example and there are various ways of dividing the scene into visualization modes pre-defined in accordance with orientation and/or position.

The visualization adjustment block is configured to select the appropriate mode in accordance with obtained orientation/position data. Each mode is characterized by parameters related to volume visualization processing. Some of these parameters are predefined and some may be calculated and/or selected in accordance with obtained orientation/position data.

For example, the parameters of volume visualization processing depend on the interest of the user, may vary depending on the visualization mode and, accordingly, may be predefined for each or for some of the visualization modes. By way of non-limiting example, a range of objects of interest may be predefined for each mode and the obtained volumetric data may be filtered accordingly.

As was detailed with reference to FIG. 2, the results of pre-processing may be transferred to the signal acquisition and processing unit 14. Accordingly, signal acquisition and/or processing parameters (e.g. the maximal range, signal integration parameters, etc.) may be modified in accordance with the adjustment requirements resulting from said pre-processing (e.g. if the range of interest is “behind the obstacle” the acquisition parameters will be configured per received results of calculation of the real position/orientation vs. the obstacle) and/or generated visualization mode (e.g. in the floor/ceiling modes the range/direction may be pre-defined other than for the wall mode; for example 5 meters and/or 30° scan versus 8 meters and/or 15° scan).

Accordingly, in certain embodiments of the present invention, automatic configuring signal acquisition/processing parameters and/or automatic selecting a proper visualization mode may result, for example, in increase of the signal-to-noise ratio as more integration time may be devoted to the portion of the signal with the range limited per the mode configuration.

By way of another non-limiting example, when viewing a room through a wall, the user is usually uninterested in objects that are above or below a certain height in relation to the imaging system. Accordingly, configuration of the wall mode may comprise limitation of position of signals to be acquired and/or visualized. By way of another non-limiting example, the volumetric data obtained in the ceiling mode may be rotated 90° (and, if necessary, further adjusted in accordance with real orientation as was detailed with reference to FIG. 3) before volume visualization, thus enabling better perception of the scene.

It should be noted that generating the visualization mode is domain (application) specific. For example, the assumption for the illustrated through-wall imaging is that the user is viewing a room with planar surfaces (walls/floor/ceiling) that are perpendicular or parallel to the gravitational vector, and is interested in a limited set of configurations. Other through-the obstacle applications and/or assumptions may result in other sets of pre-defined visualization modes.

As was disclosed in the co-pending application No. PCT/IL2007/000427 (Beeri et al.) filed Apr. 1, 2007 and assigned to the assignee of the present invention, the volume visualization processing may include (or be accompanied by) perceiving processing provided in order to facilitate a meaningful representation and/or an instant understanding of the image to be displayed. The perceiving processing may include generating one or more perceiving image ingredients to be displayed together with an image visualized in accordance with the acquired data.

In accordance with certain embodiments of the present invention, the generation of the visualization mode may comprise selecting, in accordance with obtained orientation/position data, perceiving image elements to be generated during (or together with) further volume visualization and calculating and/or selecting parameters thereof. By way of non-limiting example, such perceiving image elements include shadow, position-dependent color grade, virtual objects as, artificial objects (e.g. floor, markers, 3D boundary box, arrows, grid, icons, text, etc.), pre-recorded video images and others. The parameters automatically configured (in accordance with obtained orientation/position data) for further processing may include position and direction of artificial floor or other visual objects, scale of the color grade, volume of interest to be displayed, direction of the arrows, position of the shadow, etc. For example, the direction of perceiving images (e.g. floor, shadow, arrows, artificial clipping planes, etc.) is provided in relation to the “real space” (e.g. gravitational vector) regardless of actual sensor array orientation.

The perceiving images and parameters thereof may be pre-configured as a part of visualization mode or automatically configured during the visualization mode generation in accordance with obtained orientation/position data.

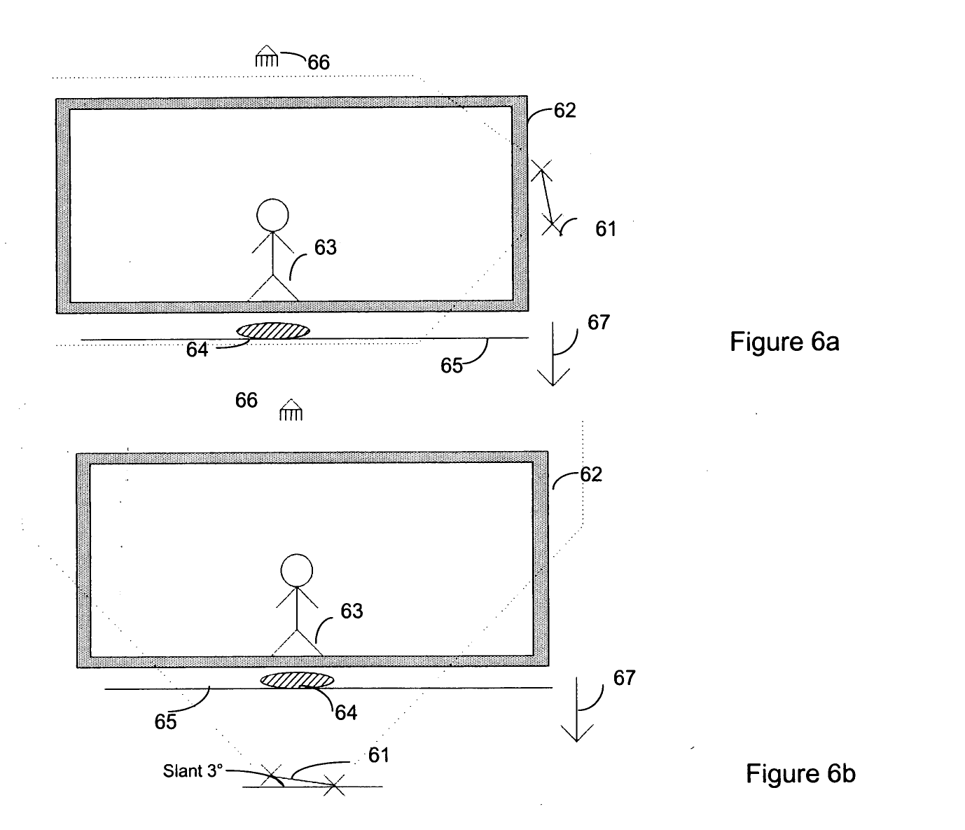

Referring to FIGS. 6a and 6b, there are illustrated fragments of a sample screen comprising an exemplary image visualized in accordance with certain aspects of the present invention. FIG. 6a illustrates the fragment with wall mode and FIG. 6b illustrates the fragment with floor mode selected in accordance with orientation of the sensor array 61.

The illustrated fragments comprise a room 62 with a standing person 63. The dotted-line outline areas are displayed to the user, said areas being different for the floor and the wall modes. Before volume rendering, the volumetric data obtained in the floor mode were rotated 90° and further adjusted (rotated back 3°) to correct the illustrated slant. The illustrated perceiving image elements (artificial floor 65, shadow 64 cast on the floor from the artificial light source 66, arrow 67 illustrating the gravity direction) are visualized in the same way versus real world coordinates regardless of the orientation of the sensor array.

It should be understood that the system according to the invention, may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

It is also to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception, upon which this disclosure is based, may readily be utilized as a basis for designing other structures, methods, and systems for carrying out the several purposes of the present invention.

Those skilled in the art will readily appreciate that various modifications and changes can be applied to the embodiments of the invention as hereinbefore described without departing from its scope, defined in and by the appended claims.

1. A method of volume visualization for use with a through-the-obstacle imaging system comprising at least one sensor array configured to obtain physical inputs informative, at least, of a part of an imaging scene concealed by one or more obstacles, the method comprising:
(a) obtaining one or more volumetric data sets corresponding to the physical inputs obtained by the sensor array;
(b) obtaining data informative of position and/or orientation of the sensor array corresponding to said obtained physical inputs;
(c) pre-processing one or more obtained volumetric data sets and/or derivatives thereof in accordance with said position and/or orientation informative data;
(d) volume visualization processing one or more obtained volumetric data sets and/or derivatives thereof in accordance with results of pre-processing.

2. The method of claim 1 wherein the sensor array is an antenna of an ultra-wideband radar.

3. The method of claim 1 wherein said position and/or orientation informative data are related to at least one item selected from a group comprising:
(a) orientation and/or position versus the gravitational vector;
(b) orientation and/or position versus certain elements of the imaging scene;
(c) orientation and/or position versus a previous orientation and/or position.

4. The method of claim 1 wherein the pre-processing comprises rotating and/or shifting at least one volumetric data set in order to provide alignment with a certain reference thus giving rise to an adjusted volumetric data set, and the volume visualization processing is provided in respect of said adjusted volumetric data set.

5. The method of claim 1 wherein the pre-processing comprises filtering at least one obtained volumetric data set in accordance with certain criteria thus giving rise to an adjusted volumetric data set, and the volume visualization processing is provided in respect of said adjusted volumetric data set.

6. The method of claim 1 wherein the pre-processing comprises aggregating two or more obtained volumetric data sets and rotating and/or shifting the aggregated volumetric data in order to provide alignment with a certain reference thus giving rise to an adjusted volumetric data; and the volume visualization processing is provided in respect of said adjusted volumetric data.

7. The method of claim 1 wherein the pre-processing comprises rotating and/or shifting two or more obtained volumetric data sets in order to provide alignment with a common reference thus giving rise to adjusted volumetric data sets, and aggregating the adjusted volumetric data sets; and the volume visualization processing is provided in respect of the aggregated adjusted volumetric data.

8. The method of claim 1 wherein the obtained orientation and/or position data comprise data related to orientation and/or position versus a previous orientation and/or position; the pre-processing comprises rotating and/or shifting at least one volumetric data set in order to correct the deviation in respect to the previous orientation and/or position thus giving rise to an adjusted volumetric data set, and the volume visualization processing is provided in respect of said adjusted volumetric data set.

9. The method of claim 1 wherein the pre-processing of the obtained volumetric data comprises generating a visualization mode in accordance with obtained orientation and/or position informative data and certain rules, and the volume visualization processing is provided in accordance with the generated visualization mode.

10. The method of claim 9 wherein generating the visualization mode comprises selection of a certain visualization mode among one or more predefined visualization modes, such selection provided in accordance with obtained orientation and/or position informative data.

11. The method of claim 10 wherein at least one obstacle is an element of a construction and at least one predefined visualization mode is selected from a group comprising a floor/ground mode, a wall mode and a ceiling mode.

12. The method of claim 10 wherein one or more parameters characterizing the pre-defined visualization mode are calculated and/or selected in accordance with obtained orientation and/or position informative data.

13. The method of claim 1 further comprising modifying one or more parameters characterizing obtaining at least one volumetric data set in accordance with results of pre-processing.

14. The method of claim 1 wherein the pre-processing comprises selecting, in accordance with obtained orientation and/or position informative data, one or more perceiving image elements to be generated during volume visualization processing.

15. The method of claim 14 wherein selecting at least one perceiving image element comprises automated configuring at least one parameter characterizing the element in accordance with obtained orientation and/or position informative data.

16. The method of claim 1 wherein pre-processing comprises automated configuring parameters of volume visualization processing in accordance with obtained orientation and/or position informative data.

17. A through-the-obstacle imaging system comprising:
(a) at least one sensor array operatively coupled to a signal acquisition and processing unit, said sensor array comprising one or more image sensors configured to obtain physical inputs informative of, at least, a part of an imaging scene concealed by one or more obstacles, and to generate respective output signal, said signal and/or derivatives thereof to be transferred to said signal acquisition and processing unit configured to receive said signal and/or derivatives thereof and to generate, accordingly, at least one volumetric data set;
(b) a volume visualization unit operatively coupled to the signal acquisition and processing unit and configured to obtain one or more volumetric data sets, to provide volume visualization processing in accordance with the obtained volumetric data sets, and to facilitate displaying the resulting image; wherein the volume visualization unit comprises a visualization adjustment block configured to provide certain pre-processing of one or more obtained volumetric data sets and/or derivatives thereof, the results of the pre-processing to be used in further volume visualization processing;
(c) at least one sensor configured to obtain data informative of position and/or orientation of the sensor array and to transfer the data and/or derivatives thereof to the visualization adjustment block; wherein the visualization adjustment block is configured to provide said pre-processing in accordance with said position and/orientation informative data and certain rules.

18. The system of claim 17 wherein the through-the-obstacle imaging system is based on an ultra-wideband radar.

19. The system of claim 17 wherein at least one sensor configured to obtain data informative of position and/or orientation of the sensor array is selected from a group comprising an accelerometer, an inclinometer, a laser range finder, a camera, an image sensor, a gyroscope, GPS, a combination thereof.

20. The system of claim 17 wherein the visualization adjustment block is operatively coupled to the signal acquisition and processing unit and configured to transfer the results of pre-processing to said unit, while the signal acquisition and processing unit is configured to modify one or more parameters characterizing generating volumetric data in accordance with received results of pre-processing.

21. The system of claim 17 wherein the pre-processing is selected from a group comprising:
(a) rotating and/or shifting at least one volumetric data set in order to provide alignment with a certain reference;
(b) filtering at least one obtained volumetric data set in accordance with certain criteria;
(c) aggregating two or more obtained volumetric data sets and rotating and/or shifting the aggregated volumetric data in order to provide alignment with a certain reference;
(d) rotating and/or shifting two or more obtained volumetric data sets in order to provide alignment with a common reference and aggregating the adjusted volumetric data sets;
(e) rotating and/or shifting at least one volumetric data set in order to correct the deviation in respect to a previous orientation and/or position;
(f) generating a visualization mode in accordance with obtained orientation and/or position informative data and certain rules;
(g) selecting, in accordance with obtained orientation and/or position informative data, one or more perceiving image elements to be generated during volume visualization processing;
(h) automated configuring parameters of volume visualization processing in accordance with obtained orientation and/or position informative data.

22. A volume visualization unit for use with a through-the-obstacle imaging system comprising at least one sensor array, the volume visualization unit configured to obtain one or more volumetric data sets, to provide volume visualization processing in accordance with the obtained volumetric data sets, and to facilitate displaying the resulting image; wherein said volume visualization unit comprises a visualization adjustment block configured to obtain data informative of position and/or orientation of the sensor array and to provide pre-processing of the obtained one or more volumetric data sets and/or derivatives thereof, the results of the pre-processing to be used for further volume visualization processing, wherein said pre-processing to be provided in accordance with said position and/or orientation informative data and certain rules.

23. The unit of claim 22 wherein the through-the-obstacle imaging system is based on an ultra-wideband radar.

24. The unit of claim 22 wherein the pre-processing is selected from a group comprising:
(a) rotating and/or shifting at least one volumetric data set in order to provide alignment with a certain reference;
(b) filtering at least one obtained volumetric data set in accordance with certain criteria;
(c) aggregating two or more obtained volumetric data sets and rotating and/or shifting the aggregated volumetric data in order to provide alignment with a certain reference;
(d) rotating and/or shifting two or more obtained volumetric data sets in order to provide alignment with a common reference and aggregating the adjusted volumetric data sets;
(e) rotating and/or shifting at least one volumetric data set in order to correct the deviation in respect to a previous orientation and/or position;
(f) generating a visualization mode in accordance with obtained orientation and/or position informative data and certain rules;
(g) selecting, in accordance with obtained orientation and/or position informative data, one or more perceiving image elements to be generated during volume visualization processing;
(h) automated configuring parameters of volume visualization processing in accordance with obtained orientation and/or position informative data.

25. A method of volume visualization for use with a ultra-wideband radar imaging system comprising at least one antenna array, the method comprising:
(a) obtaining one or more volumetric data sets corresponding to the physical inputs obtained by the antenna array;
(b) obtaining data informative of position and/or orientation of the antenna array corresponding to said obtained physical inputs;
(c) pre-processing one or more obtained volumetric data sets and/or derivatives thereof in accordance with said position and/or orientation informative data thus giving rise to adjusted volumetric data sets;
(d) volume visualization processing in respect of the adjusted volumetric data set.

26. The method of claim 25 wherein the pre-processing is selected from a group comprising:
(a) rotating and/or shifting at least one volumetric data set in order to provide alignment with a certain reference;
(b) filtering at least one obtained volumetric data set in accordance with certain criteria;
(c) aggregating two or more obtained volumetric data sets and rotating and/or shifting the aggregated volumetric data in order to provide alignment with a certain reference;
(d) rotating and/or shifting two or more obtained volumetric data sets in order to provide alignment with a common reference and aggregating the adjusted volumetric data sets;
(e) rotating and/or shifting at least one volumetric data set in order to correct the deviation in respect to a previous orientation and/or position.

27. A method of volume visualization for use with a ultra-wideband radar imaging system comprising at least one antenna array, the method comprising:
(a) obtaining one or more volumetric data sets corresponding to the physical inputs obtained by the antenna array;
(b) obtaining data informative of position and/or orientation of the antenna array corresponding to said obtained physical inputs;
(c) generating a visualization mode in accordance with obtained orientation and/or position informative data;
(d) volume visualization processing one or more obtained volumetric data sets and/or derivatives thereof in accordance with the generated visualization mode.

28. The method of claim 27 wherein generating the visualization mode comprises selection of a certain visualization mode among one or more predefined visualization modes, such selection provided in accordance with obtained orientation and/or position informative data.

29. The method of claim 28 wherein at least one obstacle is an element of a construction and at least one predefined visualization mode is selected from a group comprising a floor/ground mode, a wall mode and a ceiling mode.

30. The method of claim 28 wherein one or more parameters characterizing the pre-defined visualization mode are calculated and/or selected in accordance with obtained orientation and/or position informative data.

31. The method of claim 27 further comprising modifying one or more parameters characterizing obtaining at least one volumetric data set in accordance with the generated visualization mode.

32. The method of claim 27 wherein generating the visualization mode comprises automated selecting, in accordance with obtained orientation and/or position informative data, one or more perceiving image elements to be generated during volume visualization processing.

33. The method of claim 32 wherein selecting at least one perceiving image element comprises automated configuring at least one parameter characterizing the element in accordance with obtained orientation and/or position informative data.

34. The method of claim 27 wherein generating the visualization mode comprises automated configuring parameters of volume visualization processing in accordance with obtained orientation and/or position informative data.

35. A program storage device readable by machine, tangibly embodying a program of instructions executable by the machine to perform method steps of volume visualization for use with a through-the-obstacle imaging system comprising at least one sensor array configured to obtain physical inputs informative, at least, of a part of an imaging scene concealed by one or more obstacles, the method comprising:
(a) obtaining one or more volumetric data sets corresponding to the physical inputs obtained by the sensor array;
(b) obtaining data informative of position and/or orientation of the sensor array corresponding to said obtained physical inputs;
(c) pre-processing one or more obtained volumetric data sets and/or derivatives thereof in accordance with said position and/or orientation informative data;
(d) volume visualization processing one or more obtained volumetric data sets and/or derivatives thereof in accordance with results of pre-processing.

36. A computer program product comprising a computer useable medium having computer readable program code embodied therein of volume visualization for use with a through-the-obstacle imaging system comprising at least one sensor array configured to obtain physical inputs informative, at least, of a part of an imaging scene concealed by one or more obstacles, the computer program product comprising:
(a) computer readable program code for causing the computer to obtain one or more volumetric data sets corresponding to the physical inputs obtained by the sensor array;
(b) computer readable program code for causing the computer to obtain data informative of position and/or orientation of the sensor array corresponding to said obtained physical inputs;
(c) computer readable program code for causing the computer to perform pre-processing of one or more obtained volumetric data sets and/or derivatives thereof in accordance with said position and/or orientation informative data;
(d) computer readable program code for causing the computer to perform volume visualization processing of one or more obtained volumetric data sets and/or derivatives thereof in accordance with results of pre-processing.
